(19) United States
(12) Patent Application Publication
(10) Pub. No.: US 2004/0253862 A1
(43) Pub. Date: Dec. 16, 2004

(54) Method for providing socket on substrate and socket applied with such method

(75) Inventors: Hiroaki Masaki, Tokyo (JP); Takuma Utsumi, Tokyo (JP); Noriyuki Matsuoka, Yokohama-shi (JP)

Correspondence Address: Finnegan, Henderson, Farabow,, Garrett & Dunner, L.L.P., 1300 I Street, N.W., Washington, DC, 20005-3315, US

(73) Assignee: YAMAICHI ELECTRONICS CO., LTD.

(21) Appl. No.: 10/864,318

(22) Filed: Jun. 10, 2004

(30) Foreign Application Priority Data
Jun. 12, 2003 (JP) 2003-168414
May 12, 2004 (JP) 2004-142650

(51) Int. Cl. H01R 13/64

(52) U.S. Cl. 439/247

(57) ABSTRACT

A method is provided, comprising the steps of inserting the contact terminal section of the contact provided in a socket into a hole provided in the substrate, sliding the socket relative to a surface of the substrate on which the hole is formed, while maintaining the state in which the contact terminal section is inserted into the hole provided in the substrate, and fixing the socket and the contact terminal section to the substrate, while maintaining the state in which the socket and the contact terminal section are made to slide.

This application claims priority from Japanese Patent Application Nos. 2003-168414 filed Jun. 12, 2003 and 2004-142650 filed May 12, 2004, which are incorporated hereinto by reference.

### BACKGROUND OF THE INVENTION

1. Field of the Invention

The present invention relates to a method for providing a socket e.g. an IC socket on which is mounted a semiconductor device incorporating an integrated circuit therein on a substrate, and an IC socket applied with such a method. Particularly, it relates to a method for providing an IC socket on which is surface-mounted a semiconductor device having an IC package of a ball grid array (BGA) type on a substrate, and an IC socket applied with such a method.

2. Description of the Related Art

In the prior art, a semiconductor device (IC) as an electric part to be mounted onto a printed circuit board may be mounted into a semiconductor accommodation portion in a socket body of a socket, such as an IC socket. Thereby, an external terminal of the semiconductor device is brought into contact with a contact provided in the semiconductor accommodation portion so that the semiconductor device is electrically connected to the printed circuit board.

In such an IC socket, a stationary terminal section of the contact is inserted into a through-hole of the printed circuit board and soldered there (for example, see Japanese Patent Application Laid-open No. 4-301381(1992), and No. 11-233218(1999)).

A portion in which a contact is provided in one example of the prior art IC socket is shown in FIGS. 29 and 30.

First, a contact 103 shown in FIG. 29 is one for an IC socket 100 for mounting a semiconductor device, for example, of a flat leaded type IC package. In this regard, while the IC socket 100 has actually a plurality of contacts 103, only one of them is illustrated in FIG. 29 for the purpose of simplifying the description thereof.

The IC socket 100 is of a type in which the electric connection is made by placing a lead of the semiconductor device on an upper contacting section 104 of the respective contact 103 to be in contact with each other.

A root section 105 of the contact 103 contiguous to the upper contacting section 104 of the contact 103 is inserted into a hole 101a of a base board 101 in a socket body of the IC socket 100 and fixed there. The contact 103 is fixed to a plated through-hole 102a of a printed circuit board 102 with a solder 107 after a stationary end of a terminal section 106 coupled to one end of the root section 105 and projected outward has been inserted into the plated through-hole 102a. Thereby, the stationary end of the terminal section 106 is electrically connected to a conductive layer formed on the peripheral edge of an opening end of the plated through-hole 102a.

FIG. 30 shows contacts of an IC socket 120 for mounting a semiconductor device having an IC package of a ball grid array type. In this regard, while the IC socket 120 actually has a plurality of contacts 123 more than two, only two contacts 123 adjacent to each other are shown in FIG. 30 as representative for the purpose of simplifying the description thereof.

The IC socket 120 includes a nipping type of contacts 123 in which the electrical connection is obtained by nipping an external terminal of the semiconductor device to be mounted, such as a solder ball, between a pair of tip ends 124 of the contact 123.

A proximal end 125 of the contact 123 is inserted into a hole 121a of a base board 121 of the socket body and fixed there. The contact 123 is attached to a printed circuit board 122 with solder 127 after a stationary end of a terminal section 126 of the contact 123 contiguous to the proximal end 125 and projected outward has been is inserted into a plated through-hole 122a of the printed circuit board 122 on which the socket body is fixed.

Accordingly, the proximal end 125 of the contact 123 is fixed to the base board 121 and a stationary end of the terminal section 126 projected downward is inserted into the plated through-hole 122a of the printed circuit board 122 and soldered thereto with the solder 127 to be electrically connected to a conductive layer formed on the peripheral edge of an open end of the plated through-hole 122a.

In the above-mentioned conventional socket, such as the IC socket 100 or 120, since the electric connection is obtained by the soldering of the printed circuit board of a through-hole type with the stationary terminal section of the IC socket contact, there are problems in that the exchange of the IC socket on the printed circuit board 122 is difficult or the soldering operation of the stationary terminal sections in a number of contacts is troublesome.

### SUMMARY OF THE INVENTION

Thus, the present invention has been made to solve such problems in the prior art and an object thereof is to provide, in a socket of a surface-mounting type, a method for providing a socket on a substrate, by pressing the terminal onto the peripheral edge of the through-hole due to the elasticity of the terminal to obtain the contact of a conductive layer on the inner circumference or the peripheral edge of a though-hole of the printed circuit board after a socket terminal has been inserted into the through-hole of the printed circuit board, so that the exchange of the socket disposed on the printed circuit board becomes easy and the printed circuit board is assuredly brought into contact with the contact in a stable manner at a plurality of positions, and a socket to which is applicable this method.

That is, an object of the present invention is to provide a method for providing a socket on a substrate, capable of using a usual printed circuit board and responsive to various through-holes different in diameter in the printed circuit board by changing an amount of the sliding of the socket, as well as obtaining the stable and secure contact between the conductive layer in the inner circumference or the peripheral edge of the through-hole in the printed circuit board at a plurality of points, resulting in the elimination of the soldering operation of the socket terminal, and a socket to which this method is applicable.

To achieve the above object, the inventive method for providing a socket on a substrate, comprises inserting a contact terminal section of a contact provided in the socket into a hole provided in the substrate; sliding the socket relative to a surface of the substrate on which the hole is provided, while maintaining the state in which the contact terminal section is inserted into the hole provided in the substrate; and fixing the socket and the contact terminal section to the substrate, while maintaining the state in which the socket and the contact terminal section are made to slide.

The inventive socket comprises a socket body, a contact provided in the socket body, and a slide mechanism provided in the socket body, including at least one pair of latch arms, the slide mechanism for sliding the socket body relative to a substrate to be mounted thereto.

As described above, according to the present invention, by sliding the socket relative to the surface of the substrate on which the holes are provided after the socket terminal has been inserted into the substrate hole, it is possible to obtain the stable and secure contact between the substrate and the contact at a plurality of points because the peripheral edge of the substrate hole and the terminal are brought into contact with each other due to the elasticity of the terminal. Accordingly, since the soldering of the socket becomes unnecessary, the replacement of the socket on the substrate is easily enhanced. Also, the usual printed circuit board is usable for the socket.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a partially sectional view schematically illustrating an IC socket in a first embodiment of the present invention, prior to being mounted onto a printed circuit board;

FIG. 2 is a partially sectional view schematically illustrating the IC socket in the embodiment shown in FIG. 1, in which a terminal section of a contact of the inventive IC socket is inserted into a through-hole of the printed circuit board, together with an enlarged view of part of the printed circuit board;

FIG. 3 is a partially sectional view schematically illustrating the IC socket in the embodiment shown in FIG. 2 as sliding the IC socket in the horizontal direction to bring the contact into contact with the peripheral edge of an open end of the through-hole in the printed circuit board, together with an enlarged view of part of the printed circuit board;

FIG. 4 is an enlarged partially cross-sectional view of the contact of the inventive IC socket shown in FIG. 3 taken along the upper surface of the printed circuit board;

FIG. 5 is an enlarged partially cross-sectional view showing a modification of the contact shown in FIG. 4;

FIG. 6 is an enlarged partially cross-sectional view showing another modification of the contact shown in FIG. 4;

FIG. 7 is a schematic sectional view illustrating an IC socket in a second embodiment of the present invention, prior to being mounted onto a printed circuit board;

FIG. 8 is a sectional view illustrating a state in which a terminal section of a contact in the inventive IC socket shown in FIG. 7 is being inserted into a through-hole of the printed circuit board;

FIG. 9 is a sectional view schematically illustrating a state in which after the terminal section of the contact in the inventive IC socket shown in FIG. 8 has been inserted into the through-hole of the printed circuit board, the IC socket is slid in the horizontal direction to bring the contact into contact with the peripheral edge of the open end of the through-hole in the printed circuit board;

FIG. 10 is an enlarged partially sectional view of a modification of the IC socket contact in the second embodiment shown in FIG. 7, having projections in upper and lower portions thereof;

FIG. 11 is an enlarged partially sectional view of another modification of the IC socket contact in the second embodiment shown in FIG. 7, having a projection solely in an upper portion thereof;

FIG. 12 is a plan view of a fixing frame having a cam mechanism for sliding the IC socket of a third embodiment of the present invention;

FIG. 13 is a vertical sectional view showing the printed circuit board taken along a center line thereof together with the fixing frame shown in FIG. 12;

FIG. 14 is a plan view of an IC socket in the third embodiment of the present invention;

FIG. 15 is a front view of the IC socket shown in FIG. 14 according to the third embodiment of the present invention;

FIG. 16 is a vertical sectional view of the IC socket in the third embodiment of the present invention shown in FIG. 15 taken along a center line thereof;

FIG. 17 is a vertical sectional view of the IC socket in the third embodiment of the present invention immediately before a terminal section of a contact is inserted into a through-hole of a printed circuit board when the IC socket is inserted into the printed circuit board by using the fixing frame;

FIG. 18 is a vertical sectional view showing a terminal section of a contact of the inventive IC socket shown in FIG. 17 taken along a center line thereof, in which the terminal section of the contact thereof is inserted into the through-hole of the printed circuit board;

FIG. 19 is a vertical sectional view of the inventive IC socket shown in FIG. 18 taken along a center line thereof, in which the terminal section of the contact is inserted into the through-hole of the printed circuit board and the IC socket is slid in the horizontal direction by the cam mechanism in the fixing frame to bring the contact into contact with the peripheral edge of the through-hole of the printed circuit board;

FIG. 20 is a vertical sectional view of the inventive IC socket shown in FIG. 19 fixed onto the printed circuit board taken along a center line thereof;

FIG. 21 is a plan view of an IC socket in a fourth embodiment of the present invention;

FIG. 22 is an elevation view of the IC socket in the fourth embodiment shown in FIG. 21, prior to being mounted to the printed circuit board;

FIG. 23 is a vertical sectional view of the inventive IC socket in the fourth embodiment shown in FIG. 22 taken along a center line thereof;

FIG. 24 is a sectional view of the IC socket according to the fourth embodiment of the present invention, in which the terminal section of the contact is closer to a printed circuit board than in a state shown in FIG. 22 to be immediately before being inserted into the through-hole of the printed circuit board;

FIG. 25 is a vertical sectional view of the IC socket according to the fourth embodiment shown in FIG. 22 taken along a center line thereof in a state in which the terminal section of the contact thereof is inserted into the through-hole of a printed circuit board;

FIG. 26 is a vertical sectional view of the IC socket according to the fourth embodiment taken along a center line thereof in a state in which the terminal section of the IC socket contact is inserted into the through-hole of a printed circuit board and then slid in the horizontal direction to bring the contact into contact with the peripheral edge of the through-hole of the printed circuit board;

FIG. 27 is a vertical sectional view of the IC socket shown in FIG. 26 taken along a center line thereof in a state fixed on a printed circuit board;

FIG. 28 is an enlarged partially sectional view of a main part of a modified latch arm of the inventive IC socket shown in FIG. 27;

FIG. 29 is a partially sectional view of an example of a contact in a conventional IC socket; and

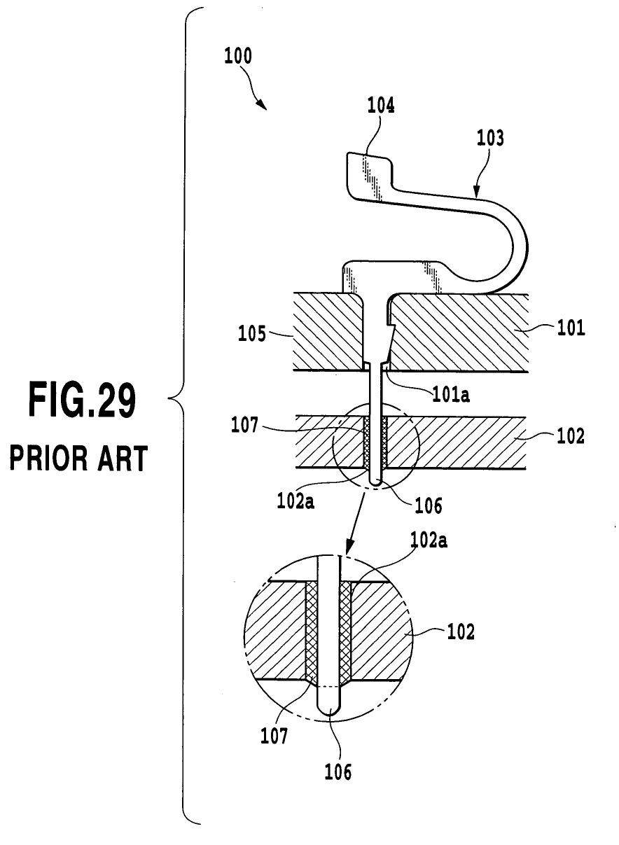

FIG. 30 is a sectional view of an example of a nipping type contact in a conventional IC socket.

### DETAILED DESCRIPTION OF PREFERRED EMBODIMENTS

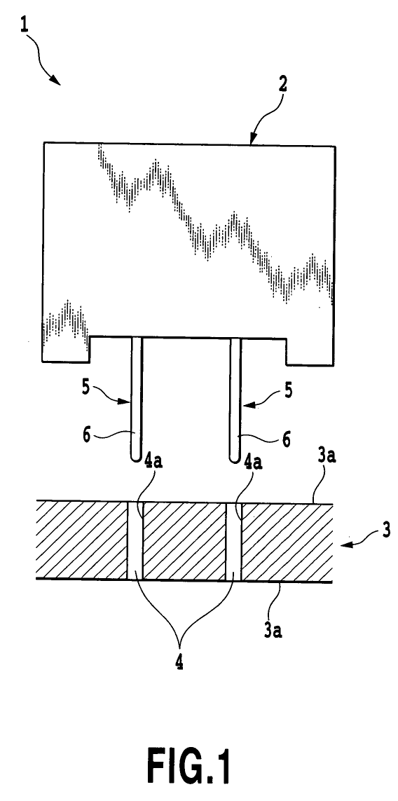

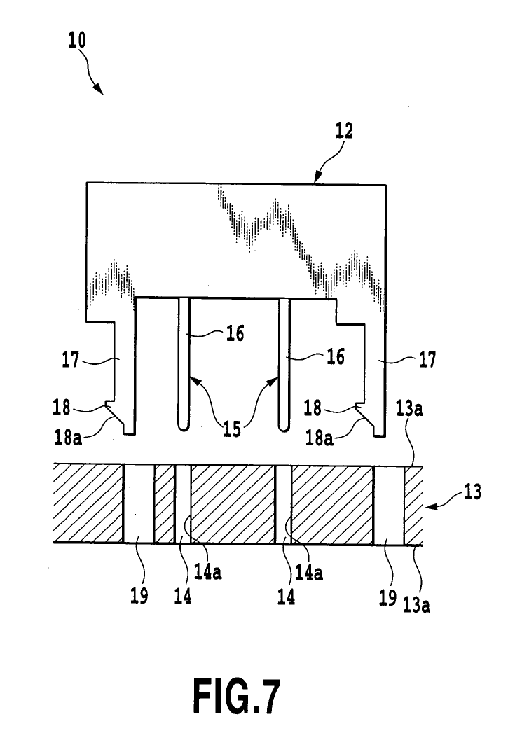

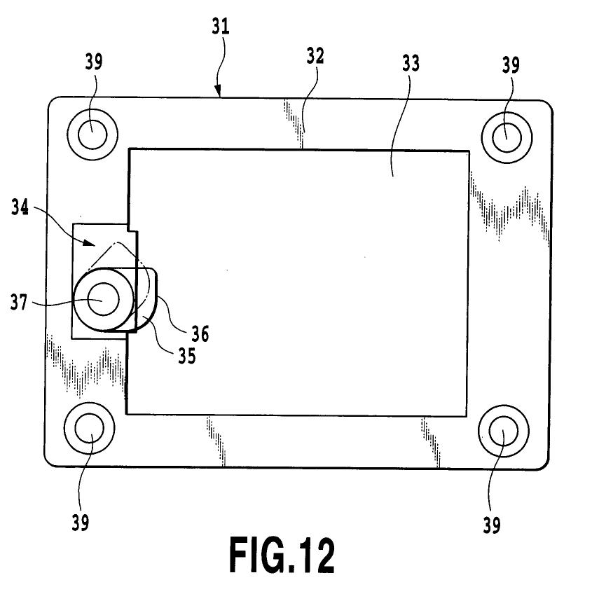

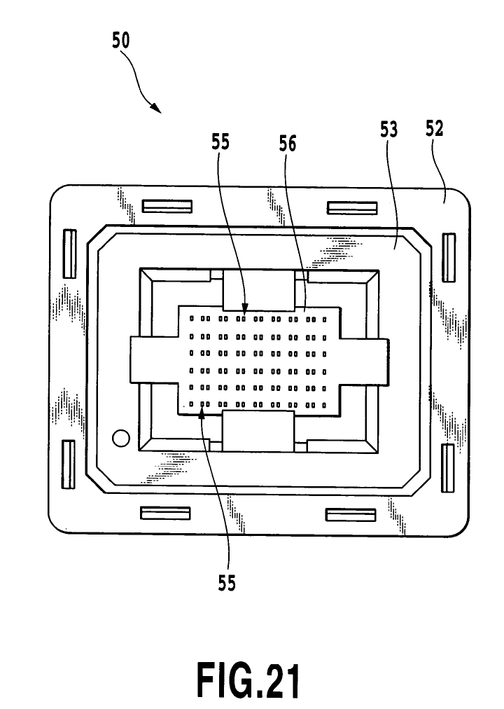

First to fourth embodiments of an IC socket are shown in the attached drawings, to which is applied the inventive method for providing a socket on a substrate. The first embodiment is shown in FIGS. 1 to 6, and the second embodiment is shown in FIGS. 7 to 11. Also, the third embodiment is shown in FIGS. 12 to 20, and the fourth embodiment is shown in FIGS. 21 to 28.

(First Embodiment)

FIGS. 1 to 4 illustrate a first embodiment of the inventive IC socket.

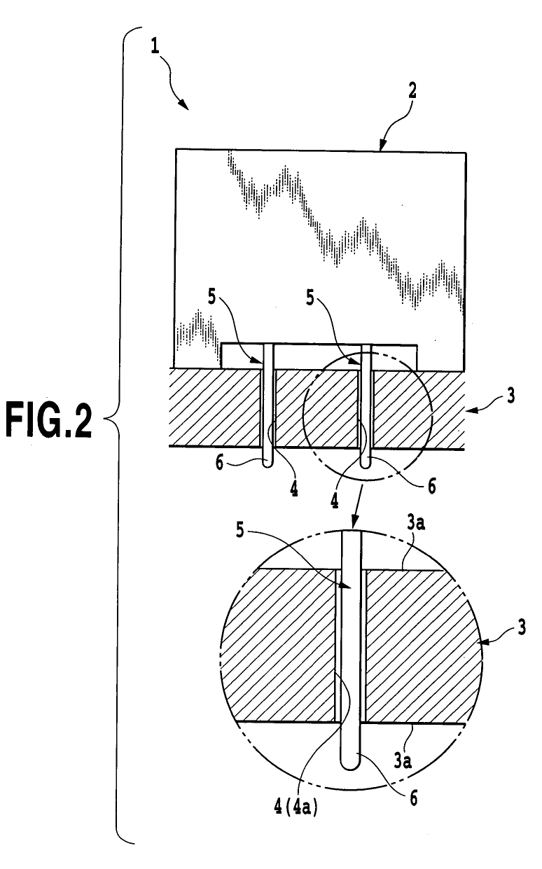

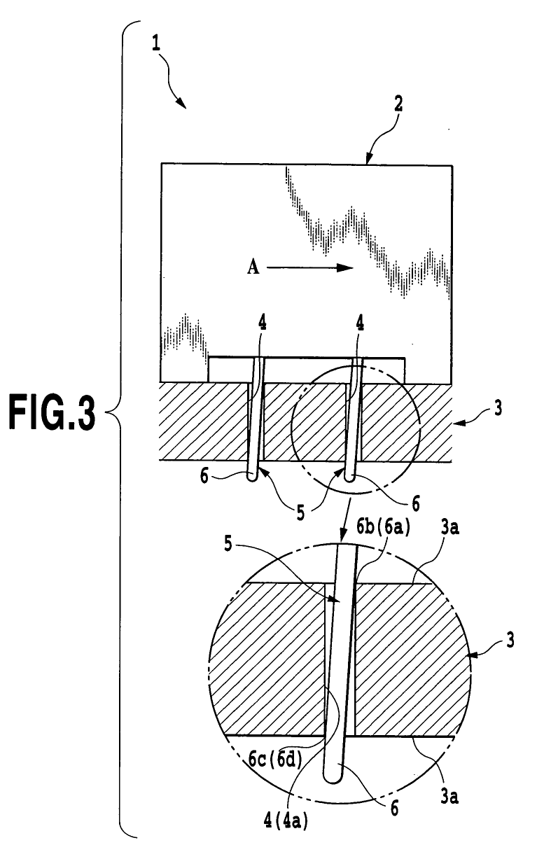

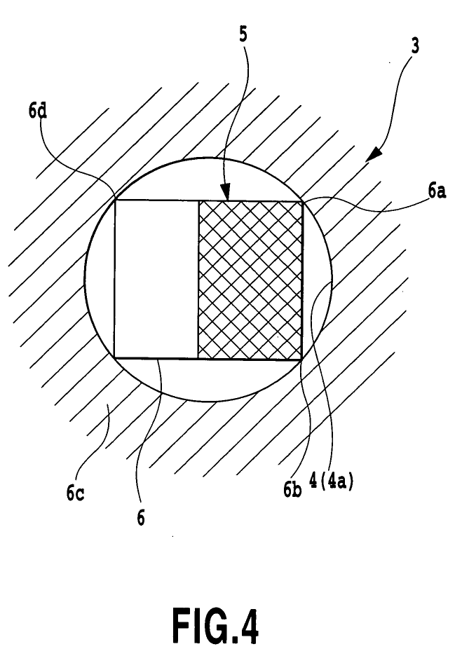

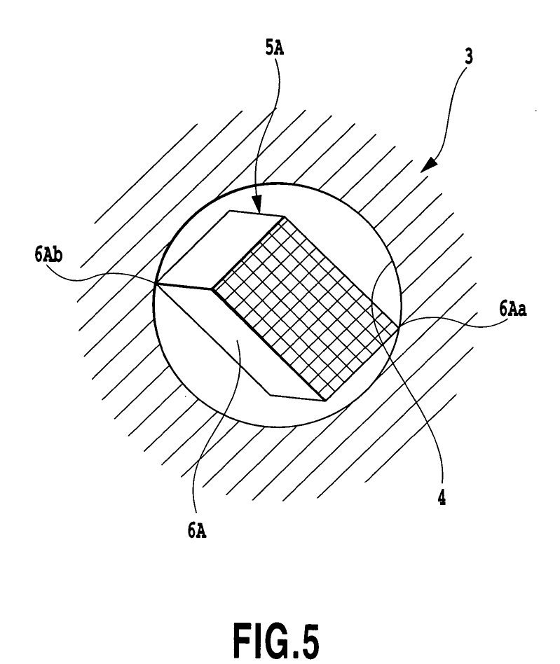

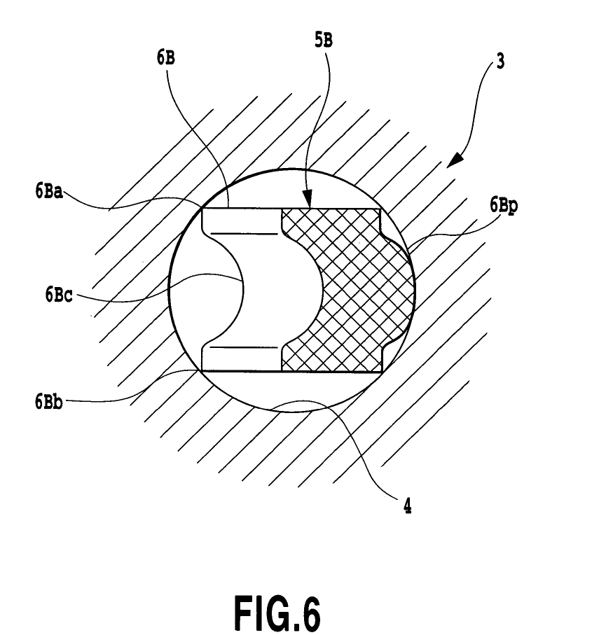

FIG. 1 is a sectional view illustrating the IC socket in accordance with the present invention, prior to being mounted onto a printed circuit board, and FIG. 2 is a sectional view illustrating the IC socket shown in FIG. 1, in which a terminal section of a contact of the inventive IC socket is inserted into a through-hole of the printed circuit board. FIG. 3 is a sectional view illustrating the IC socket shown in FIG. 2, in a state which the socket is slid in the horizontal direction to bring the contact into contact with the peripheral edge of the through-hole in the printed circuit board, and FIG. 4 is an enlarged partially lateral sectional view of the contact of the inventive IC socket shown in FIG. 3 taken along the upper surface of the printed circuit board. Also, FIGS. 5 and 6 are enlarged partially lateral sectional views of modifications of the contact shown in FIG. 4.

As shown in FIG. 1, the IC socket 1 in accordance with the present invention is capable of mounting a semiconductor device having an IC package, for example, of a ball grid array (BGA) type or a land grid array (LGA) type in a detachable manner.

the IC socket 1 is provided with a socket body 2 having a plurality of contacts 5 for the electric connection with a conductive layer formed on the inner circumference of a through-hole 4 in a printed circuit board 3 described later or on the peripheral edge of an open end of the through-hole 4.

In this regard, in FIG. 1, only two of the contacts 5 are shown as a representative of the plurality of contacts 5 for the purpose of simplifying the description.

The socket body 2 of the inventive IC socket 1 described above is mounted onto the printed circuit board 3 such as a test board or a burn-in board. The printed circuit board 3 made of relatively thin insulative material is provided with a plurality of through-holes 4 at a predetermined pitch, into which are inserted the terminal sections 6 of the respective contacts 5 described later. The through-hole 4 has a diameter larger than that of the terminal section 6 described later and is a plated-through-hole plated with metal in the inner circumferential wall thereof to form a conductive layer 4a. Open ends of the through-hole 4 are electrically connected with lands (conductors) 3a, respectively, formed on opposite surfaces of the printed circuit board 3. In this regard, the through-hole 4 may not be limited thereto, but be a plain hole having lands on opposite ends or a landless plated-through hole.

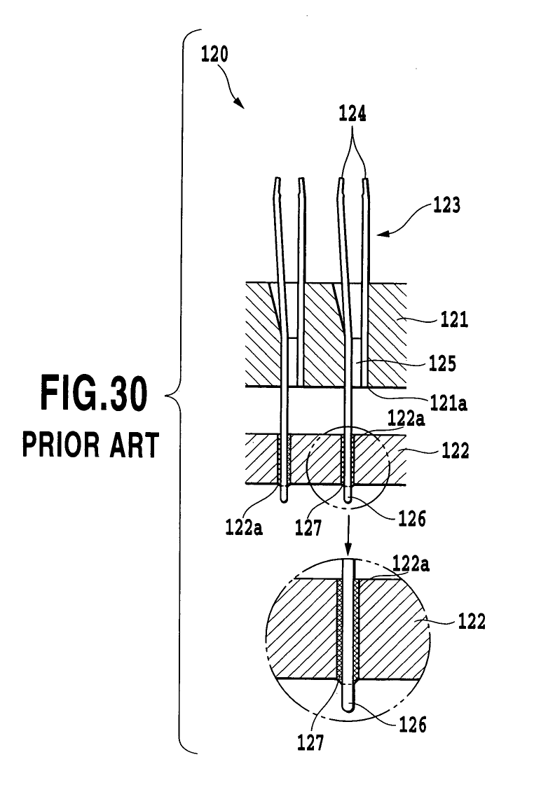

In the socket body 2 constructed to mount a semiconductor device (not shown) having a ball grid array (BGA) type IC package, in the same manner as in the contact shown in FIG. 30, there is a semiconductor device accommodation portion in the interior thereof, in which are arranged a plurality of contacts 5, each having a pair of movable contact points at a tip end thereof. The respective contacts 5 are arranged in the semiconductor device accommodation portion in correspondence to electrode sections of the semiconductor device mounted thereto.

A base of the contact 5 in the socket body 2 of the inventive IC socket is fixed to a bottom wall defining the semiconductor device accommodation portion, and a terminal section 6 contiguous to the base of the contact 5 extends downward from the bottom wall of the socket body 2 as shown in FIG. 1.

There is a positioning member in the semiconductor device accommodation portion, for positioning an electrode section of the mounted semiconductor device relative to the movable contact point of the contact 5. At a position beneath the semiconductor device accommodation portion, there is a contact motion controlling member for moving the pair of movable contact points of the contact 5 closer to or away from each other in response to the attachment or detachment of the semiconductor device relative to the semiconductor device accommodation portion.

On the other hand, the socket body 2 adapted to mount a semiconductor device (not shown) having an IC package, for example, of a land grid array (LGA) type has a semiconductor device accommodation portion in the interior thereof, for arranging a plurality of contacts 5, each having an elastically deformable contact point at a tip end thereof. Not illustrated, a positioning member is provided in the semiconductor device accommodation portion, for positioning the electrode section of the mounted semiconductor device relative to the contact point of the contact 5. The base of the contact 5 in the socket body 2 of the inventive IC socket 1 is fixed to a bottom wall defining the semiconductor device accommodation portion, and a terminal section 6 contiguous to the base of the contact 5 extends downward from the bottom wall of the socket body 2.

In one embodiment of the present invention, the terminal section 6 of the contact 5 in the IC socket 1 is inserted into the through-hole 4 of the printed circuit board 3 corresponding thereto and then slid to an extent, which fixes the IC socket 1 to the printed circuit board 3.

When the inventive IC socket 1 described above is attached to the printed circuit board 3, first, the IC socket 1 is disposed over the printed circuit board 3 while coinciding axes of the terminal sections 6 of the contacts 5 with center axes of the through-holes 4 in the printed circuit board 3 as shown in FIG. 1 each other, and then the terminal sections 6 are inserted into the through-holes 4 of the printed circuit board 3 as shown in FIG. 2. Thereby, a predetermined gap is formed between the outer circumference of the terminal section 6 and the inner circumference forming the through-hole 4.

Then, as shown in FIG. 2, the terminal section 6 of the contact 5 in the IC socket 1 is completely inserted into the through-hole 4 of the printed circuit board 3. At this time, the tip end of the terminal section passes through the printed circuit board 3 to be sufficiently projected downward from the surface of the printed circuit board 3.

Subsequently, when the bottom surface of the socket body 2 is brought into contact with the upper surface of the printed circuit board 3 as shown in FIG. 2, the socket body 2 is slid on the printed circuit board 3 in the direction shown by an arrow A in FIG. 3, i.e., generally parallel to the surface of the printed circuit board 3, that is, in the horizontal direction, while maintaining the touch between the both so that the axis of the terminal section 6 is inclined at a predetermined angle relative to the center axis of the through-hole 4.

An amount of sliding is determined by a pressure of the terminal section 6 of the contact 5. That is, the amount of sliding corresponds to a gap between the inner circumference of the through-hole 4 and the outer circumference of the terminal section 6 and is preferably determined so that a portion of the terminal section 6 crossing the surface of the printed circuit board 3 is brought into contact with the latter at a predetermined pressure.

As a result, the outer circumference surface of the terminal section 6 of the contact 5 is inclined within the through-hole 4 of the printed circuit board 3 to be in contact with upper and lower edges of the through-hole 4 as shown in the drawing. In this case, as shown in FIG. 4, the terminal section 6 of the contact 5 is brought into contact with the upper edge of the through-hole 4 at one corner of the rectangular cross-section of the terminal section 6 of the contact 5 and with the lower edge of the through-hole 4 at the opposite other corner of the cross-section thereof.

In other words, each of these contacts 5 has a rectangular lateral cross-section i.e., oblong lateral cross-section in the terminal section 6, and two (upper) corners 6a and 6b thereof as touching points on the right side in FIG. 4 are brought into contact with the wall surface of the upper edge of the through-hole 4. Also, two (lower) corners 6c and 6d thereof as touching points on the left side thereof in FIG. 4 are brought into contact with the wall surface of the lower edge of the through-hole 4. Accordingly, the terminal section 6 of the contact 5 is suitably brought into contact with the peripheral edges of the open end of the through-hole 4 in the printed circuit board 3 at a plurality of touching points 6a to 6d, i.e., four touching points.

By using a suitable fixing member while maintaining the contact 5 in contact with the peripheral edges of the open ends of the through-hole 4 in the printed circuit board 3, the socket body 2 is fixed onto the printed circuit board 3, for example, by being threaded screws into female-threaded holes (not shown) in the socket body 2 via attachment holes in the printed circuit board 3.

FIG. 5 shows a contact 5A which is a modification of the contact in FIG. 4. The contact 5A has a cross-section of a terminal section 6A to be inserted into the through-hole 4, which is formed to rotate the terminal section 6 of the contact 5 shown in FIG. 4 by approximately 45 degrees about a longitudinal axis thereof. Thereby, the contact 5A is brought into contact with the upper edge of the through-hole 4 in the printed circuit board 3 at one corner 6Aa as a touching point of the terminal section 6A. Also, it is brought into contact with the lower edge of the through-hole 4 at another corner 6Ab as a touching point on the opposite side of the terminal section 6A. Accordingly, the terminal section 6A of the contact 5A is favorably brought into contact with the peripheral edge of the open ends of the through-hole 4 in the printed circuit board 3 at these corners.

FIG. 6 illustrates a contact 5B which is another modification of the contact 4 in FIG. 4. A lateral cross-sectional shape of the terminal section 6B in the contact 5B is a convex shape having a rounded projection 6Bp and a rounded recess 6Bc.

Thereby, the contact 5B is brought into line-contact with the wall surface of the open end of the through-hole 4 in the printed circuit board 3 by the rounded projection 6Bp of the terminal section 6B at the upper edge of the through-hole 4. Opposite corners 6Ba and 6Bb at both sides of the recess 6Bc on the opposite side of the terminal section 6B are brought into two point-contact with the lower edge of the through-hole 4.

Accordingly, the terminal section 6A of the contact 5B is favorably electrically connected to the conductor on the peripheral edge of the open end of the through-hole 4 in the printed circuit board 3 by these one line-contact portion and two point-contact portions.

Further, even in the contacts 5A and 5B shown in FIGS. 5 and 6, the socket body 2 is fixed to the printed circuit board 3 by means of fastening members such as screws while bringing the contacts 5A and 5B into contact with the peripheral edges of the open ends of the through-hole 4 in the printed circuit board 3.

Further, while the illustrated inventive IC socket 1 is used for mounting a semiconductor device provided with a ball grid array type IC package having external terminals such as hemispherical or spherical solder balls, the IC socket 1 is not limited to be used for the ball grid array type IC package, but may be optionally used for other semiconductor device having an IC package of other type such as a land grid array type.

(Second Embodiment)

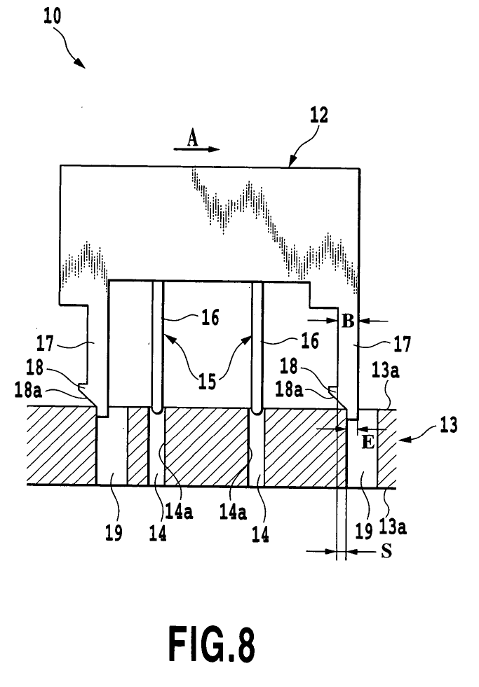

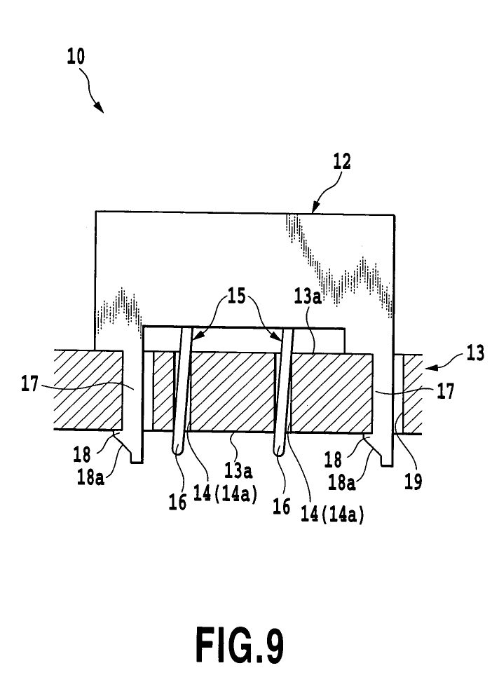

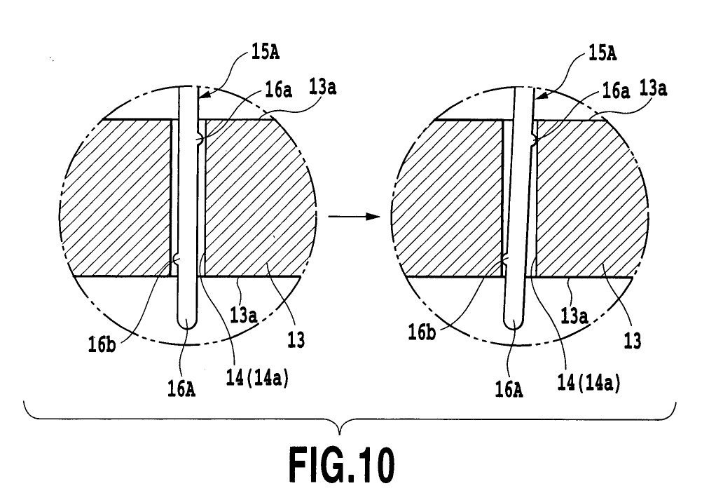

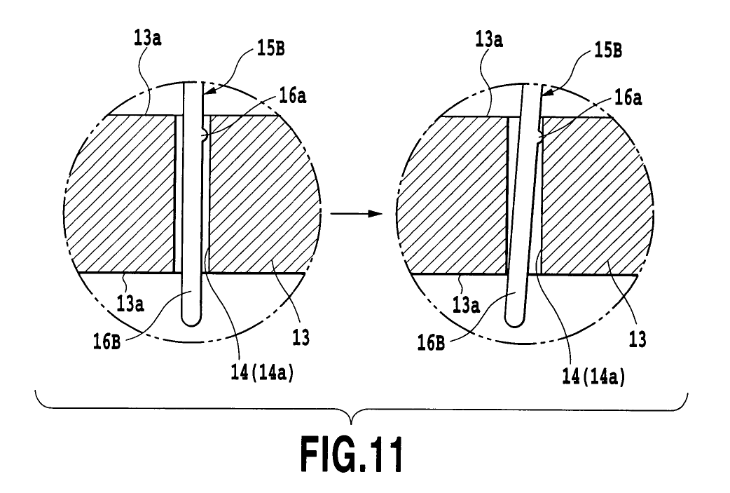

FIGS. 7 to 9 illustrate a second embodiment of an IC socket in accordance with the present invention. Particularly, FIG. 7 is a sectional view illustrating the inventive IC socket, prior to being mounted onto a printed circuit board. FIG. 8 is a sectional view illustrating a state in which a terminal section of a contact in the inventive IC socket shown in FIG. 7 is being inserted into a through-hole of the printed circuit board. FIG. 9 is a sectional view illustrating a state in which after the terminal section of the contact in the inventive IC socket shown in FIG. 8 has been inserted into the through-hole of the printed circuit board, the IC socket is slid in the horizontal direction to bring the contact into contact with the peripheral edge of the open end of the through-hole in the printed circuit board. Also, FIG. 10 is an enlarged sectional partially view of a modification of the IC socket contact in the second embodiment shown in FIG. 7, having projections in upper and lower portions thereof. FIG. 11 is an enlarged partially sectional view of another modification of the IC socket contact in the second embodiment shown in FIG. 7, having a projection solely in an upper portion thereof.

As shown in FIG. 7, the inventive IC socket 10 is capable of mounting a semiconductor device having an IC package, for example, of a ball grid array (BGA) type or a land grid array (LGA) type in a detachable manner similar to the IC socket 1 described above.

The IC socket 10 is provided with a socket body 12 having a plurality of contacts 15 for the electrical connection of conductive layers on an inner circumference of through-holes 14 in a printed circuit board 13 described later or conductive layers formed on the peripheral edges of open ends of the through-holes 14 with a group of terminals in the semiconductor device.

In this regard, only two contacts 15 in the plurality of ones are shown in FIG. 7 as a representative for the purpose of simplifying the description.

The socket body 12 of the inventive IC socket 10 described above is mounted onto the printed circuit board 13 such as a test board or a burn-in board. The printed circuit board 13 made of insulative material has a plurality of through-holes 14 into which are inserted terminal sections 16 of the contacts 15 described later at a predetermined pitch. The through-hole 14 has a diameter larger than that of the terminal section 16 described later, and is a plated through-hole having a conductive layer 14a plated on the inner circumferential wall thereof with metal. Open ends of the through-hole 14 are electrically connected, respectively, with lands (conductors) 13a formed on the printed circuit board 13. In this regard, the through-hole 14 should not be limited to such an example but may be a plain hole having lands at opposite ends thereof or a landless plated-through hole.

The socket body 12 has a semiconductor device accommodation portion in the interior thereof, in which a plurality of contacts 15 as with the contact shown in FIG. 30, each having a pair of movable contact points at a tip end thereof, are arranged when the semiconductor device (not shown) provided, for example, with an IC package of a ball grid array (BGA) type is mounted thereon. The respective contacts 15 are arranged in correspondence with the electrode sections of the semiconductor device to be mounted.

A base of the contact 15 in the socket body 12 of the inventive IC socket 1 is fixed to the bottom wall defining the semiconductor device accommodation portion, and the terminal section 16 of the contact 15 contiguous to the base extends downward from the bottom wall of the socket body 12.

Not illustrated, there is a positioning member in the semiconductor device accommodation portion, for positioning the electrode section of the mounted semiconductor device relative to the movable contact point of the contact 15. Also, at a position beneath the semiconductor device accommodation portion, there is a contact motion controlling member for moving the pair of movable contact points of the contact 15 closer to or away from each other in response to the attachment or detachment of the semiconductor device relative to the semiconductor device accommodation portion.

On the other hand, the socket body 12 adapted to mount a semiconductor device (not shown) having an IC package, for example, of a land grid array (LGA) type has a semiconductor device accommodation portion in the interior thereof, for arranging a plurality of contacts 15, each having an elastically deformable contact point at a tip end thereof. The respective contacts 15 are arranged in correspondence with the electrode sections of the semiconductor device to be mounted.

Not illustrated, a positioning member is provided in the semiconductor device accommodation portion, for positioning the electrode section of the mounted semiconductor device relative to the contact point of the contact 15. The base of the contact 15 in the socket body 12 of the inventive IC socket 10 is fixed to a bottom wall defining the semiconductor device accommodation portion, and a terminal section 16 contiguous to the base of the contact 15 extends downward from the bottom wall of the socket body 12 as shown in FIG. 7.

Further, the inventive IC socket 10 has one pair or a plurality of pairs of latch arms 17 extending downward from a lower portion of the socket body 12 generally parallel to the terminal sections 16. In the vicinity of a tip end of the latch arm 17, there is a latch nib 18. In the printed circuit board 13, a latch hole 19 is provided adjacent to the through-hole 14 in correspondence to the respective latch arm 17. The respective latch hole 19 has an inner diameter larger than that of the through-hole 14.

As shown in FIG. 9, the latch nib 18 is engaged with the edge of the latch hole 19 when one end of the latch arm 17 is inserted into the latch hole 19 and passes through the same. Thereby, the socket body 12 is supported to the printed circuit board 13 to attach the IC socket 10 onto the printed circuit board 13.

The inventive IC socket 10 of the second embodiment described above is disposed as shown in FIG. 7 to be mounted to the printed circuit board 13. That is, as shown in FIG. 7, the terminal sections 16 of the contacts 15 are arranged above the printed circuit board 13 so that an axis of the terminal section 16 coincides with a center axis of the through-hole 14 of the printed circuit board 13.

Then, the terminal section 16 of the contact 15 in the inventive socket 10 is inserted into the through-hole 14 of the printed circuit board 13. Thereby, a gap is defined between the outer circumference of the terminal section 16 and the inner circumference of the through-hole 14. Simultaneously, the latch arm 17 of the inventive IC socket 10 is inserted into the latch hole 19 of the printed circuit board 13. An initial stage of the above operation is shown in FIG. 8.

As the contact 15 and the latch arm 17 of the IC socket 10 are further inserted into the corresponding through-hole 14 and latch hole 19 in a state as shown in FIG. 8, respectively, the nib 18 of the latch arm 17 touches on the upper edge of the latch hole 19 in the printed circuit board 13. Thereby, the latch arm 17 and the socket body 12 are slid generally parallel to the surface of the printed circuit board 13 along a taper surface 18a of the nib 18 in contact with the peripheral edge of the latch hole 19, that is, in the lateral direction indicated by an arrow A in FIG. 8.

Accordingly, the terminal section 16 of the contact 15 inserted into the through-hole 14 of the printed circuit board 13 is inclined within the through-hole 14 at a predetermined angle as well as curved and flexed to a some extent.

When the contact 15 and the latch arm 17 of the IC socket are completely inserted into the through-hole 14 and the latch hole 19 of the printed circuit board 13, respectively, so that tip ends thereof are projected out of the through-hole 14 and the latch hole 19, the nib 18 of the latch arm 17 is exposed from the latch hole 19.

Thereby, the socket body 12 is slid back in the lateral direction opposite to that indicated by the arrow A in FIG. 8 relative to the printed circuit board 13, whereby the nib 18 is engaged with the peripheral edge of the latch hole 19 in the printed circuit board 13.

Accordingly, the socket body 12 of the IC socket 10 is fixed to the printed circuit board 13 and secured thereto. An amount S of sliding at this time is determined to be a required value in accordance with a pressure applied to a portion of the terminal section 16 of the contact 15 crossing the surface of the printed circuit board 13. That is, the sliding amount S is a value determined by a width B of a root portion and a width E of a tip end portion of the latch arm 17 shown in FIG. 8, and is set in correspondence to a gap between the inner circumference of the through-hole 14 and the outer circumference of the terminal section 16.

By sliding the socket body 12 back in the horizontal direction opposite to the direction indicated by the arrow A by the sliding amount S, it is possible to attach the IC socket 10 to the printed circuit board 13. In addition, by means of the latching nib 18 of the latch arm 17, the socket body 12 of the inventive IC socket 10 is latched to the printed circuit 13 and secured thereto. Thus, the socket body 12 is firmly fixed to the printed circuit board 13. Also, the motion of the socket body 12 at this time in the horizontal direction indicated by the arrow A may be caused by other suitable means or assisted by the elasticity based on the deformation of the terminal section 16 of the contact 15 when the latter is inserted.

As described above, according to the second embodiment of the present invention, the socket body 12 of the IC socket 10 is attached while sliding in the horizontal direction on the printed circuit board 13 to be firmly latched thereto by the nib 18 of the latch arm 17. As a result, the terminal section 16 of the contact 15 is inclined in the through-hole 14 of the printed circuit board 13 to be in contact with the upper and lower edges of the through-hole 14 as shown in FIG. 9.

In this case, the terminal section 16 of the contact 15 is brought into contact with the upper edge of the through-hole 14 on one side and with the lower edge thereof on the other side. While maintaining this state in which the terminal section 16 is brought into contact with the peripheral edges of the through-hole 14, the socket body 12 is fixed to the printed circuit board 13 by fastening means such as screws.

The terminal section 16 of the contact 15 has, of course, optional lateral cross-sectional shapes, for example, of rectangle, square, circle, oval or convex as in the preceding first embodiment.

FIGS. 10 and 11 illustrate contacts 15A and 15B, respectively, which are modifications of the contact shown in FIG. 7. The contact 15A has projections 16a and 16b in upper and lower portions of a terminal section 16A in the contact 15A, respectively (see FIG. 10), and the contact 15B has a projection 16a solely in an upper portion of a terminal section 16B thereof (see FIG. 11).

By providing the projections 16a, 16b in the terminal section 16A, 16B of contact 15A, 15B in such a manner, the projections 16a and 16b are brought into contact with a wall surface of the through-hole 14 in the printed circuit board 13 to result in a favorable contact. Accordingly, it is possible to obtain the firm contact of the terminal sections 16A and 16B of the contacts 15A and 15B with the peripheral edge of the through-hole 14 in the printed circuit board 13. Thus, the terminal sections 16A and 16B of the contacts 15A and 15B are adapted to have the desirable electric connection with the conductive layer 14a of the through-hole 14 in the printed circuit board 13.

(Third Embodiment)

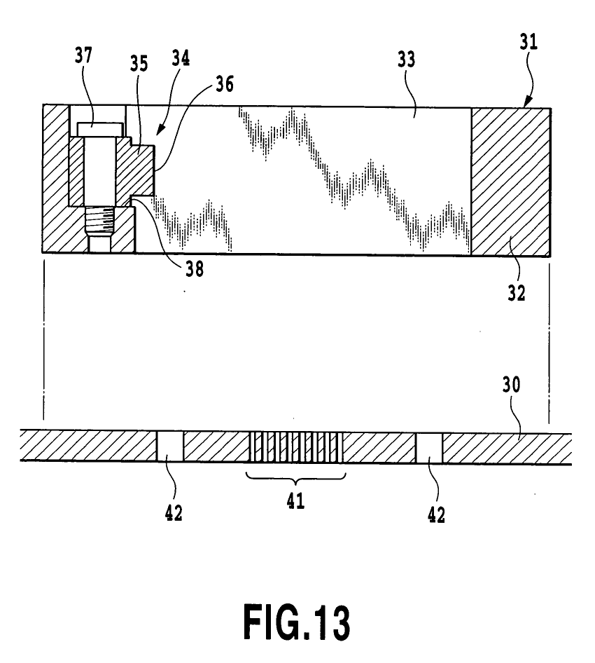

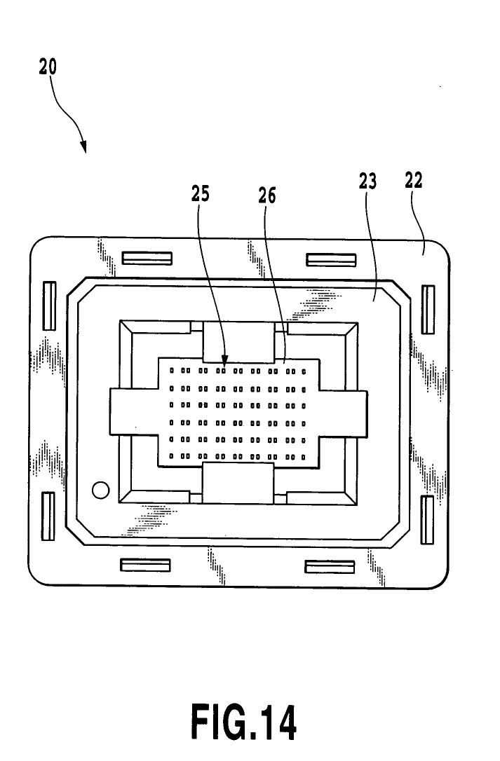

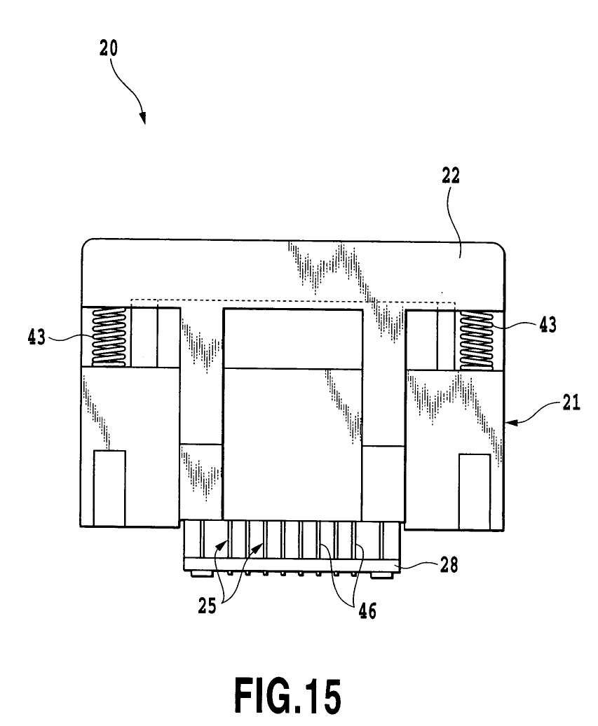

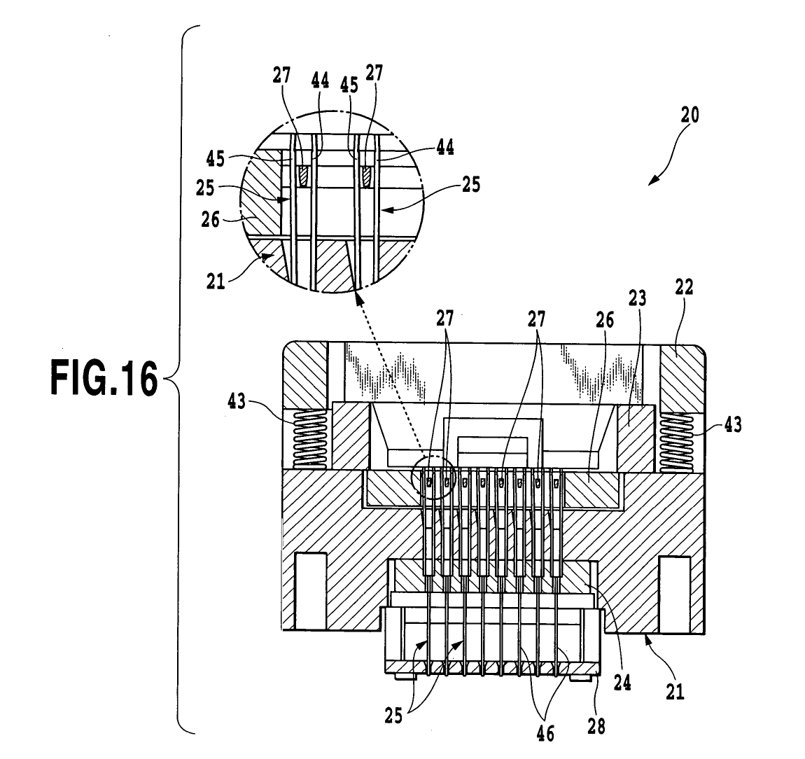

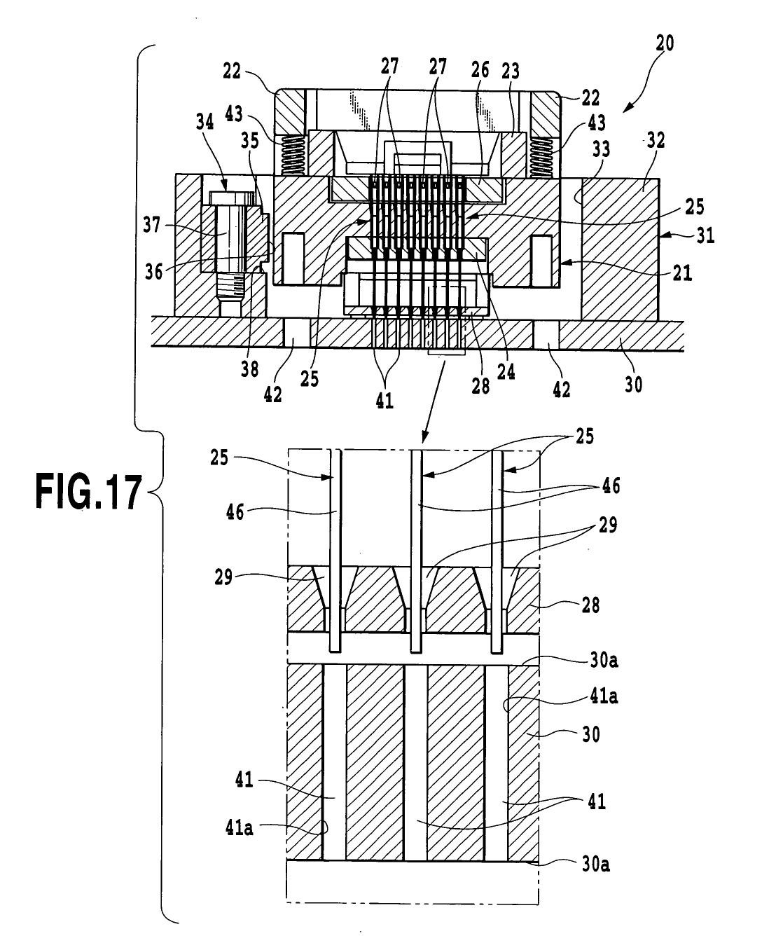

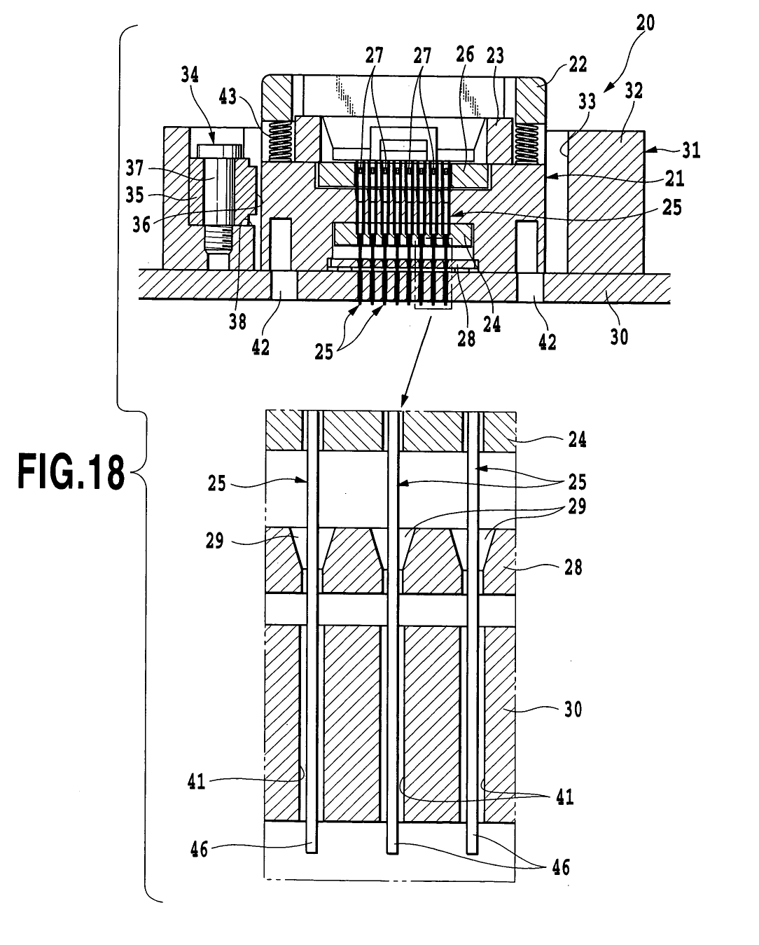

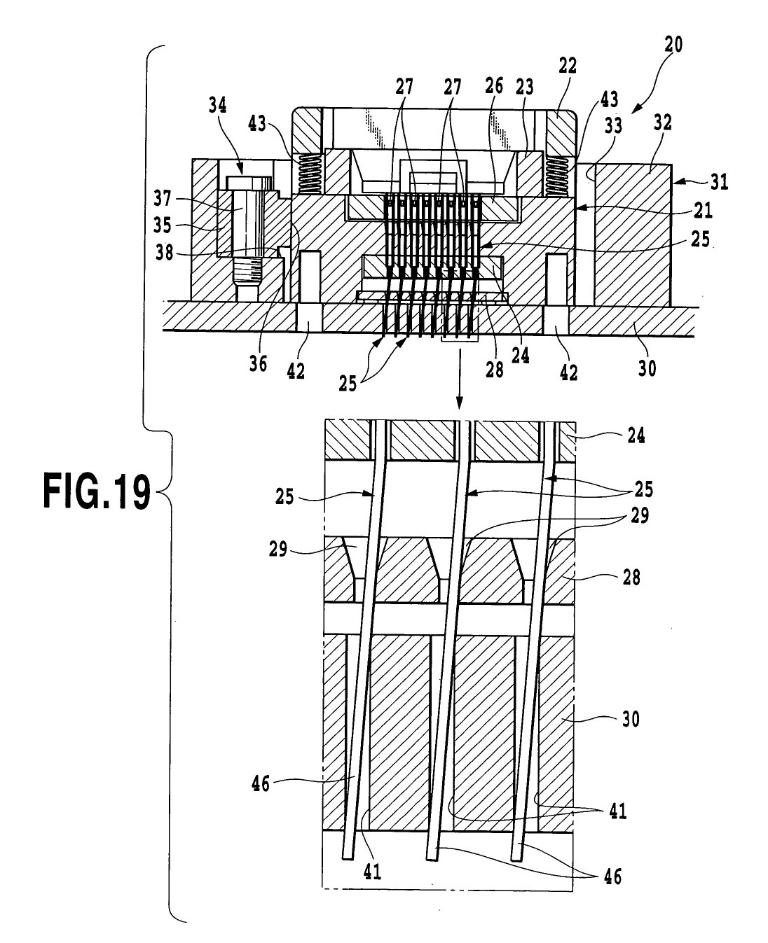

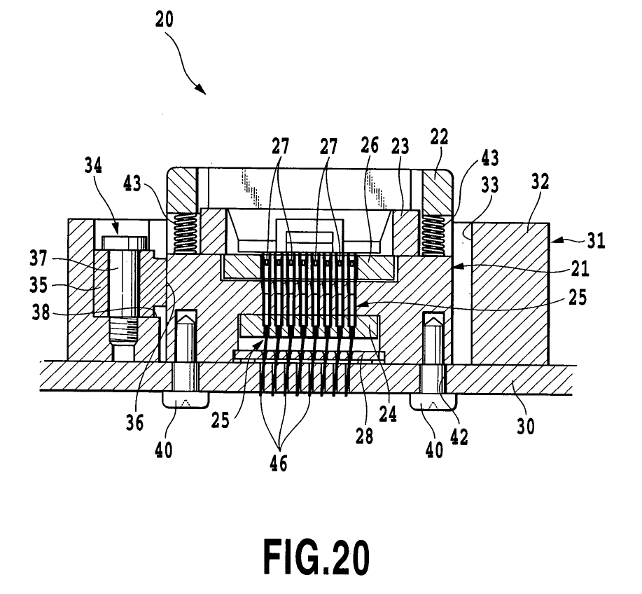

FIGS. 12 to 20 illustrate a third embodiment of the inventive IC socket, wherein FIG. 12 a plan view of a fixing frame having a cam mechanism for sliding the inventive IC socket; FIG. 13 is a vertical sectional view showing the printed circuit board taken along a center line thereof together with the fixing frame shown in FIG. 12; FIG. 14 is a plan view of the inventive IC socket in the third embodiment; FIG. 15 is a front view of the IC socket shown in FIG. 14; FIG. 16 is a vertical sectional view of the IC socket shown in FIG. 15 taken along a center line thereof; FIG. 17 is a vertical sectional view of the inventive IC socket in the third embodiment taken along a center line thereof before it is mounted to the printed circuit board by using the fixing frame; FIG. 18 is a vertical sectional view of the inventive IC socket shown in FIG. 17 taken along a center line thereof, in which the terminal section of the contact thereof is inserted into the through-hole of the printed circuit board; FIG. 19 is a vertical sectional view of the inventive IC socket shown in FIG. 18 taken along a center line thereof, in which the terminal section of the contact is inserted into the through-hole of the printed circuit board and the IC socket is slid in the horizontal direction by the cam mechanism in the fixing frame to bring the contact into contact with the peripheral edge of the through-hole of the printed circuit board; and FIG. 20 is a vertical sectional view of the inventive IC socket shown in FIG. 19 fixed onto the printed circuit board taken along a center line thereof.

First, as shown in FIGS. 12 and 13, a fixing frame 31 having a cam mechanism 34 used in the inventive IC socket 20 of a third embodiment is formed of a rectangular frame member 32. Attachment screw holes 39 are provided at four corners thereof so that the frame member is attached and secured to the printed circuit board by suitable screw members. There is an opening 33 for a space for accommodating the IC socket in the interior of the fixing frame 31, having a shape and a dimension corresponding to the contour of the used IC socket 20. Further, there is a stepwise recess 38 on one side of the frame member 32. A cam member 35 of the cam mechanism 34 is pivoted in this recess 38 by a screw 37.

FIGS. 14 to 20 illustrate a structure of the inventive IC socket 20 in the third embodiment using the fixing frame 31 provided with such a cam mechanism 34 and a method for mounting the same to the printed circuit board.

First, the inventive IC socket 20 of the third embodiment is shown in FIGS. 14 to 16. As illustrated, the inventive IC socket 20 is, for example, of an open-top type.

The inventive IC socket 20 of an open-top type includes a socket body 21 to be attached to a printed circuit board 30 such as a test board or a burn-in board, a cover member 22 supported by a plurality of elastic members 43 such as coil springs to be movable upward/downward relative to the socket body 21, a package-mounting member 23 for guiding and positioning the semiconductor device, a plurality of contacts 25 of a nipping type to be connected to external terminals, such as solder balls, of the semiconductor device mounted to the package-mounting member 23, and a moving plate 26 having a grid-like partitioning wall 27 for opening/closing a tip ends of the contacts 25.

In the third embodiment of the inventive IC socket, a contact-holding plate 24 on which the contacts 25 are arranged and fixed is attached and secured in the interior of the socket body 21. Further, the contact 25 has a stationary side elastic piece 44 and a movable side elastic piece 45, which are projected upward from the contact-holding plate 24 attached to the socket body 21. It is devised to nip the external terminal of the semiconductor device between tip ends of the stationary side elastic piece 44 and the movable side elastic piece 45 so that the electric connection between the both is obtained.

The contact 25 extend so that a terminal section 46 of the contact 25 projects downward from the socket body 21. In correspondence to the contacts 25, there are through-holes 41 in the printed circuit board 30, for receiving the terminal sections 46 of the contacts 25 in the IC socket 20. The through-hole 41 is a plated through-hole having a diameter larger than that of the terminal section 46 and a conductive layer 41a formed by plating metal in the inner circumferential wall in the same manner as in the preceding embodiment. Open ends of the through-hole 41 are electrically connected to lands (conductors) 30a, respectively, formed on the printed circuit board 30. In this regard, the through-hole should not be limited thereto but may be a plain hole having lands at opposite ends thereof or a landless plated through-hole.

Further, holes 42 for screws for fixing the socket body 21 to the printed circuit board 30 are provided.

In addition, a lower end tip portion of the terminal section 46 of the contact 25 is inserted into an array hole 29 of a contact-array plate 28 in the IC socket 20 to be accurately positioned to a printed circuit of the printed circuit board 30. In this regard, the contact-array plate 28 may be eliminated if unnecessary. That is, when the contacts 25 are favorably arranged and retained by the contact-holding plate 24, the contact-array plate 28 may be unnecessary and could be eliminated.

FIGS. 17 to 20 illustrate the steps for attaching the inventive IC socket of the third embodiment thus structured to the printed circuit board.

When the inventive IC socket 20 according to the third embodiment is mounted to the printed circuit board 30, the fixing frame 31 having the cam mechanism 34 is first positioned to attachment holes 39 (see FIG. 12) and fixed to the printed circuit board 30 by suitable fastening means such as screws. In the opening 33 of the fixing frame 31 thus fixed to the printed circuit board 30, the inventive IC socket 20 is located as shown in FIG. 17. In this state, the terminal sections 46 of the contacts 25 in the IC socket 20 are located in the array holes 29 of the contact-array plate 28 to maintain the correct arrangement. Accordingly, the terminal sections 46 of the contacts 25 in the IC socket 20 coincide with the through-holes 41 of the printed circuit board 30.

Then, the inventive IC socket 20 is pushed down toward the printed circuit board 30 and firmly brought into contact with the printed circuit board 30 from above.

At this time, the terminal section 46 of the contact 25 in the IC socket 20 is inserted into the through-hole 41 of the printed circuit board 30 while smoothly guided by the array hole 29 of the array plate 28. This state is shown in FIG. 18. In this state, the terminal section 46 of the contact 25 is not at all brought into contact with the through-hole 41 of the printed circuit board 30.

Next, in the state shown in FIG. 18, the cam mechanism 34 of the fixing frame 31 is operated to push the socket body 21 of the IC socket 20 in the lateral direction by cam surface 36 of means of the cam member 35. Thereby, the inventive IC socket 20 is made to slide in the horizontal direction on a surface of the printed circuit board 30 forming the through-hole 41.

An amount of sliding at this time is determined by a magnitude of the cam operation of the cam member 35 in the cam mechanism 34. Thereby, the IC socket 20 is made to slide at the predetermined amount.

Accordingly, since the terminal section 26 of the contact 25 inserted into the through-hole 41 of the printed circuit board 30 is inclined within the through-hole 41 as shown in FIG. 19, it is brought into contact with the upper and lower edges of the through-hole 14, respectively.

In this case, one side of the terminal section 46 of the contact 25 is brought into contact with the upper edge of the through-hole 41, and the other side thereof with the lower edge of the through-hole 41.

In such a manner, the terminal section 46 of the contact 25 is favorably brought into contact with the printed circuit board 30 at the upper and lower edges of the through-hole 41 to result in the suitable electric connection thereby.

When the terminal section 46 of the contact 25 is inclined within the through-hole 41 of the printed circuit board 30 to be brought into contact with the upper and lower edges thereof as described above, screws 40 are screw-engaged via the holes 42 to fix the IC socket 20 to the printed circuit board 30.

Accordingly, in the inventive IC socket 20, the cover member 22 is pushed to move the moving plate 26 in the lateral direction. Thereby, the movable side elastic piece 45 of the contact 25 is displaced outward by the partitioning wall 27 to open the contact 25. At this time, the semiconductor device is attached to the package-mounting member 23 from the upper side of the IC socket 20 and mounted there. When the pressure of the cover member 22 is released, the cover member 22 is pushed upward by the elastic member 43 to come close the movable side elastic piece 45 relative to the stationary side elastic piece 44. Thereby, the external terminal of the semiconductor device is nipped between the tip ends of the contact 25. Thus, the favorable electric connection of the semiconductor device with the required printed circuit of the printed circuit board 30 is obtainable via the contact 25.

In this regard, the illustrated inventive IC socket 20 is capable of mounting a semiconductor device provided with an IC package of a ball grid array type having external terminals of hemispherical or spherical ball-shaped solder. The IC socket 20, however, should not be limited to be used for the above-mentioned semiconductor device having the IC package of the ball grid array type, but, of course, may be optionally applicable to a semiconductor device having an IC package of other type, such as a land grid array type.

According to the inventive IC socket 20 thus structured, the terminal section 46 of the contact 25 is inserted into the through-hole 41 of the printed circuit board 30, and by sliding the moving plate 26 in the horizontal direction, the terminal section 46 of the contact 25 is brought into contact with the upper and lower edges of the through-hole 41 in the printed circuit board 30. Thereby, it is possible to have a plurality of contacting portions with the contact 25 to facilitate the replacement of the IC socket on the printed circuit board. Also, since the stable and improved contact of the printed circuit board 30 with the contact 25 is obtained at a plurality of touching portions, the soldering of the IC socket becomes unnecessary. Thereby, it is possible to obtain an IC socket capable of using a usual printed circuit board and corresponding to various through-holes having different diameters by changing the sliding amount.

(Fourth Embodiment)

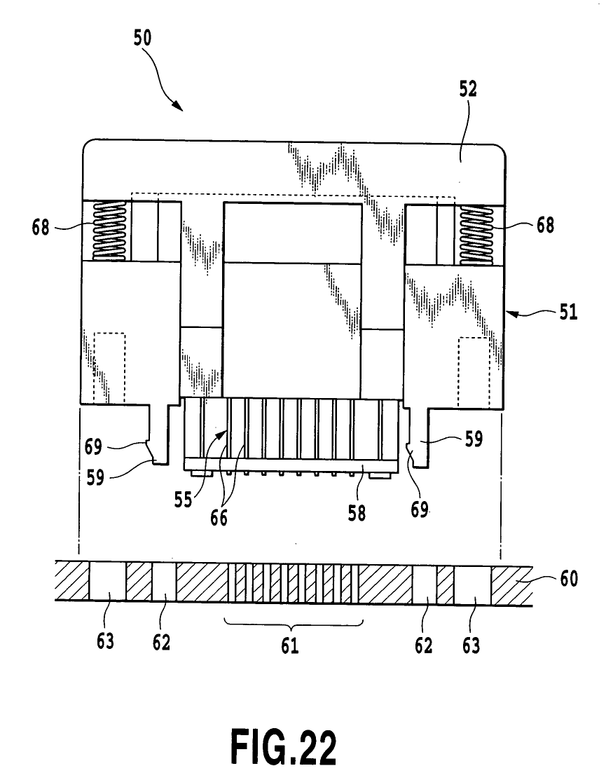

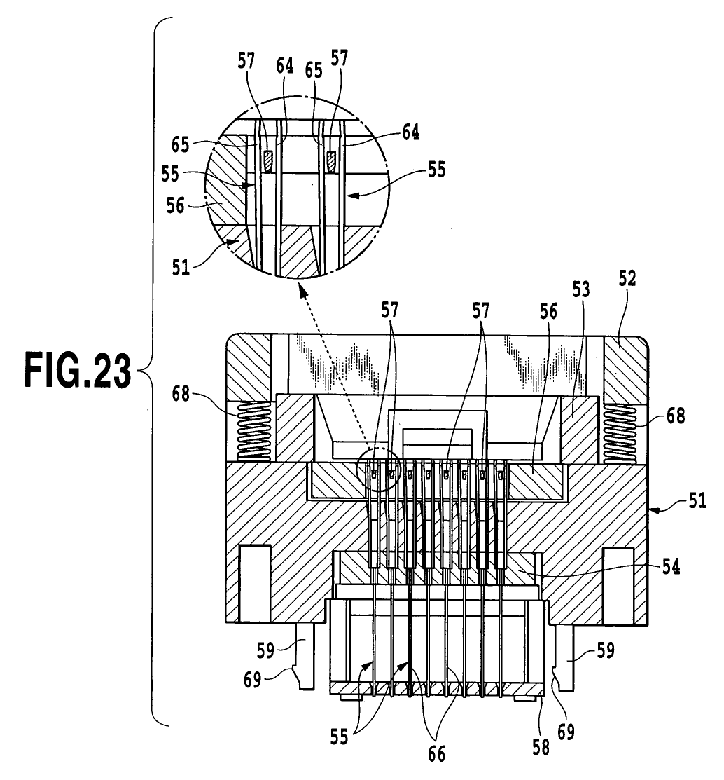

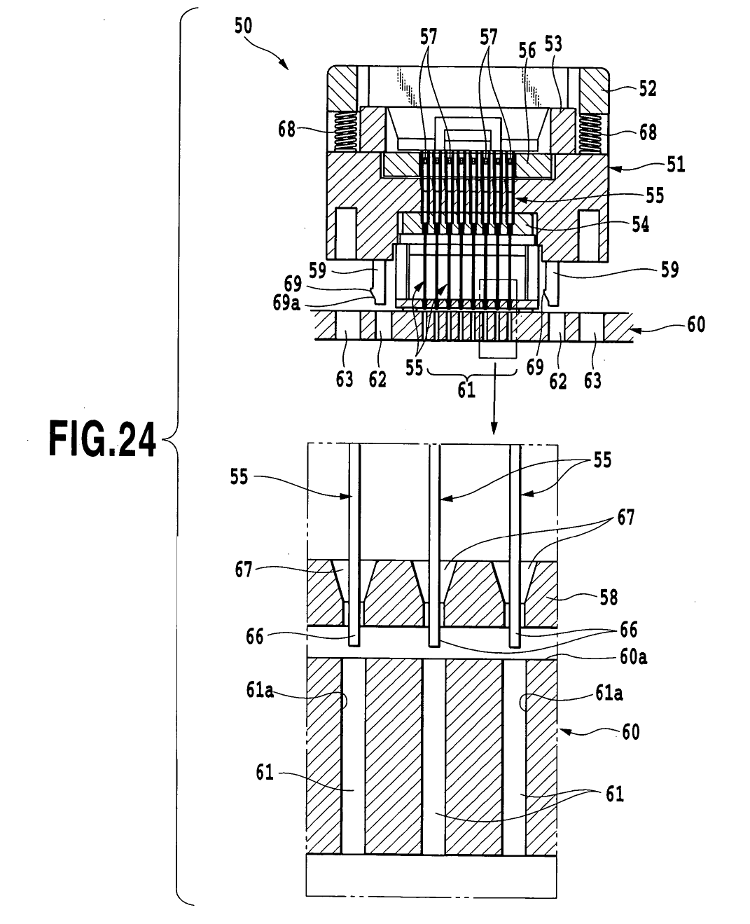

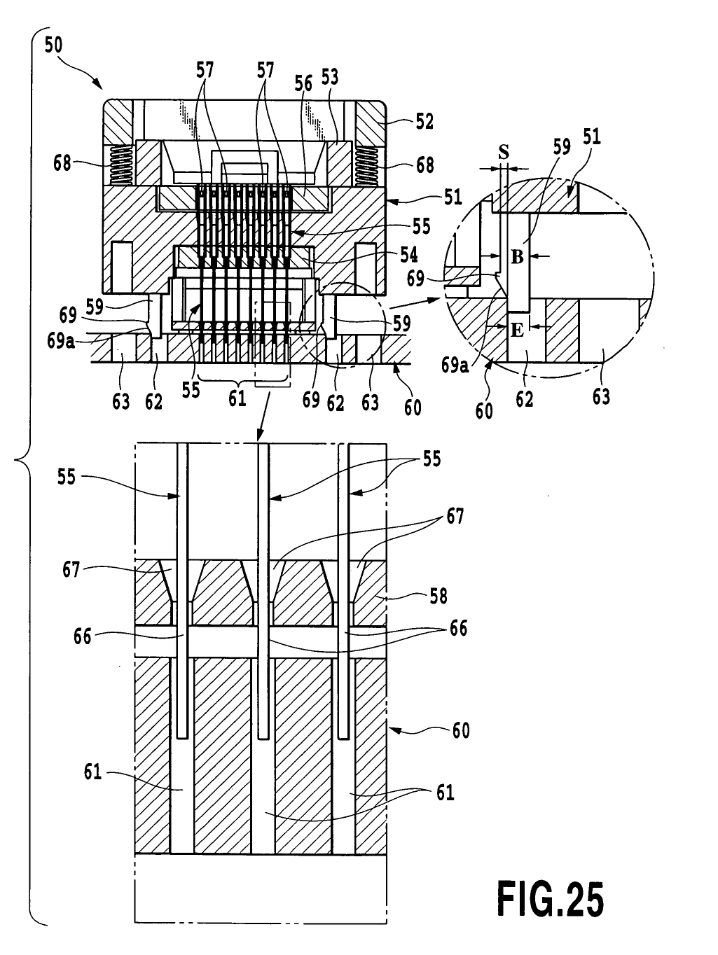

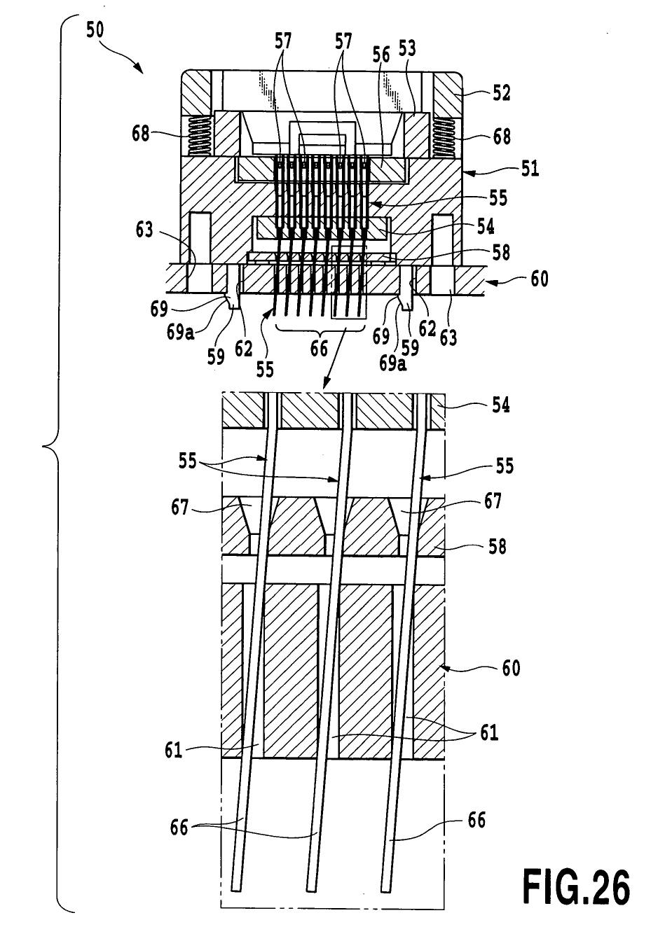

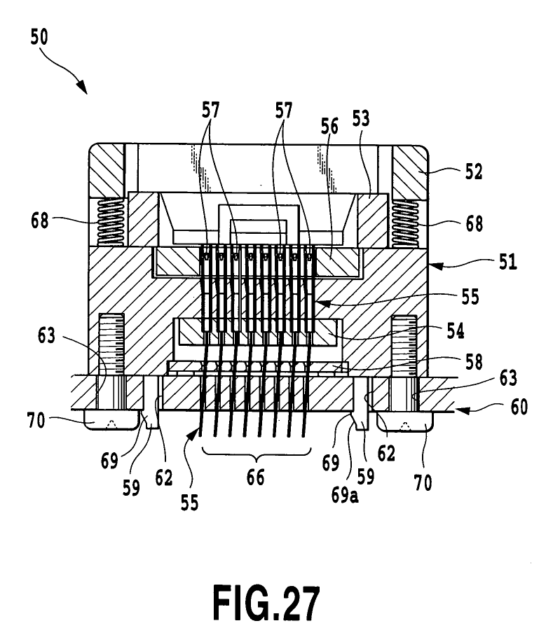

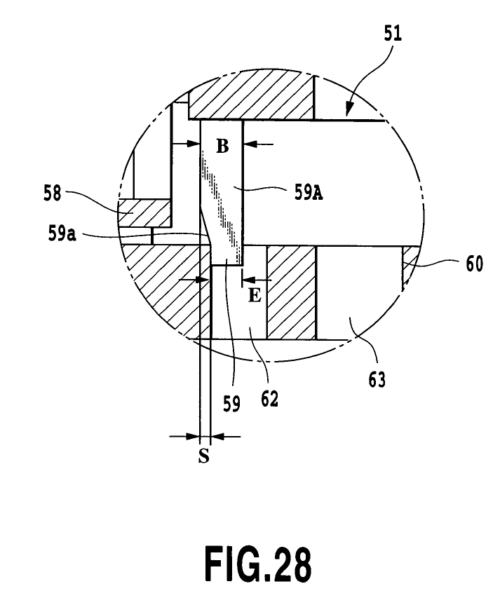

FIGS. 21 to 27 illustrate a fourth embodiment of the inventive IC socket, respectively. FIG. 21 is a plan view of the inventive IC socket, and FIG. 22 is a front view prior to mounting the inventive IC socket onto a printed circuit board. FIG. 23 is a vertical sectional view of the inventive IC socket shown in FIG. 22 taken along a center line thereof, and FIG. 24 is a sectional view subsequent to FIG. 22, prior to inserting a terminal section of a contact in the inventive IC socket into a through-hole of the printed circuit board, including an enlarged partially sectional view. FIG. 25 is a vertical sectional view of the inventive IC socket in which the terminal section of the contact is inserted into the through-hole of the printed circuit board taken along a center line thereof, including enlarged partially sectional views. FIG. 26 is a vertical sectional view of the inventive IC socket taken along a center line thereof, in which, after the terminal section of the contact is inserted into the through-hole of the printed circuit board, the IC socket is slid in the horizontal direction to bring the contact into contact with the printed circuit board, including an enlarged partially sectional view. FIG. 27 is a vertical sectional view taken along a center line thereof, in which the IC socket shown in FIG. 26 is fixed to the printed circuit board. Also, FIG. 28 is an enlarged partially sectional view illustrating a latch arm of the inventive IC socket shown in FIG. 27.

As shown in FIGS. 21 to 23, the inventive IC socket 50 of the fourth embodiment is of a type having contacts 55 for mounting a semiconductor device thereon, having an IC package of a ball grid array type or a land grid array type to form the electric connection between the both.

As illustrated, the IC socket 50 of the fourth embodiment in accordance with the present invention includes a socket body 51 to be attached to a printed circuit board 60 such as a test board or a burn-in board, a cover member 52 supported by elastic members 63 such as a plurality of coil springs to be movable upward and downward relative to the socket body 51, a package-mounting member 53 for guiding the semiconductor device and positioning the same, a plurality of contacts 55 of a nipping type for the connection with external terminals such as solder balls in the semiconductor device mounted onto the package-mounting member 53, and a moving plate 56 provided with a grid-like partitioning wall 57 for opening and closing a tip end of the contact 55.

In the inventive IC socket 50 of the fourth embodiment, the contacts 55 are arranged in a contact-holding plate 54 and retained there. The contact-holding plate 54 is fixed to the socket body 51. Further, the contact 55 has a stationary side piece 64 and a movable side piece 65 projected upward from the contact-holding plate 54 attached to the socket body 51. The semiconductor device is electrically connected to the contact 55 by nipping the external terminal of the semiconductor device between tip ends of the stationary side piece 64 and the movable side piece 65.

The contact 55 extends so that a terminal section 66 of the contact 55 is projected downward from the socket body 51. In correspondence to these contacts 55, through-holes 61 are provided for receiving the terminal sections 66 of the contacts 55 in the IC socket 50. As shown in FIG. 24, the through-hole 61 has a diameter larger than that of the terminal section 66 in the same manner as in the above-mentioned embodiment, and is a plated through-hole having a conductive layer 60a formed by the metallic plating treatment in the inner circumferential wall thereof. Opposite open ends of the through-hole 61 are electrically connected, respectively, to lands (conductors) 60a formed on printed circuit board 60. In this regard, the through-hole 61 should not be limited to such a type, but may be a plain hole having lands at opposite ends thereof or a landless plated through hole.

Further, latch holes 62 engaged with latch arms 59 for latching the socket body 61 to the printed circuit board 60 and sliding the same in the horizontal direction, and holes 63 for screw members for fixing the socket body 51 to the printed circuit board 60 are provided.

In the inventive IC socket 50, one pair or a plurality of pairs of latch arms 59 extend downward from the socket body 52, and a latching nib 69 is provided in the vicinity of a tip end of the respective latch arm 59. In correspondence to these latch arms 59, there are latch holes 62 in the printed circuit board 60, into which are inserted the latch arms 59, respectively, to engage the nibs 69 with the edges of the latch holes 62. Thereby, the socket body 52 is secured to the printed circuit board 60 so that the IC socket 50 is mounted to the printed circuit board 60.

In the inventive IC socket 50 of the fourth embodiment, the contacts 55 are attached to the socket body 52 by the contact-holding plate 54 and extend downward from the socket body 52 so that the terminal sections 66 thereof are projected out thereof.

The steps for mounting the inventive IC socket 50 of the fourth embodiment onto the printed circuit board 60 are illustrated in FIGS. 22 to 27.

The inventive IC socket 50 is first disposed relative to the printed circuit board 60 as shown in FIG. 22. In this state, the latch arm 59 is positioned in correspondence to the latch hole 62 of the printed circuit board 60.

Then, the inventive IC socket 50 descends to be a state shown in FIG. 24, and the terminal section 66 of the contact 55 is inserted into the through-hole 61 of the printed circuit board 60. Simultaneously therewith, the latch arm 59 of the inventive IC socket 50 is inserted into the latch hole 62 of the printed circuit board 60. Such a state is illustrated in FIG. 25.

The IC socket 50 is further descend relative to the printed circuit board 60 from the state shown in FIG. 25 so that the contact 55 and the latch arm 59 of the IC socket 50 are further more inserted into the through-hole 61 and the latch hole 62, respectively, corresponding thereto. Accordingly, the nib 69 of the latch arm 59 touches on the upper edge of the latch hole 62 in the printed circuit board 60 and slides in the lateral direction along a tapered surface 69a of the nib 69. Thereby, the terminal section 66 of the contact 55 inserted into the through-hole 61 for the contact in the printed circuit board 60 is inclined within the through-hole 61 and curved to flex to a some extent.

When the contact 55 and the latch arm 59 of the IC socket 50 are completely inserted into the through-hole 61 and the latch hole 62 of the printed circuit board 60, the nib 69 of the latch arm 59 is exposed from underside of the latch hole 62. By sliding the socket body 51 at this time in the horizontal direction relative to the surface of the printed circuit board 60 on which are formed the through-holes 61, the nib 69 is latch-engaged with the lower surface of the printed circuit board 60. Thereby, the socket body 51 of the IC socket 50 is firmly secured to the printed circuit board 60. Further, by screw-engaging screws 70 with the screw holes 63, the socket body 51 is mounted to the printed circuit board 60.

In this case, the socket body 51 slides in the horizontal direction by a sliding amount S to attach the IC socket 50 to the printed circuit board 60. In addition, since the socket body 51 of the inventive IC socket 50 is latched and fixed to the printed circuit board 60 by the nib 69 of the latch arm 59, the socket body 51 is securely attached to the printed circuit board 60 in association with the attachment by means of the screws 70.

The amount S of sliding is a value determined by the pressure of the terminal section 66 of the contact 55. The sliding amount S at this time can be determined by changing a width B of a root portion and a width E of a tip end portion of the latch arm 59 as shown in FIG. 25.

In the fourth embodiment of the present invention, the socket body 51 of the IC socket 50 is slid on the printed circuit board 60 in the horizontal direction when mounted. At that time, the socket body 51 is firmly latched to the printed circuit board 60 by the nib 69 of the latch arm 69 and further firmly fixed thereto by the screws 70.

As a result, the terminal section 66 of the contact 55 is inclined within the through-hole 61 of the printed circuit board 60, and brought into contact with the upper and lower edges of the through-hole 61 as shown in FIGS. 26 and 27.

In this case, as illustrated, the contact 55 is brought into contact with the upper edge of the through-hole 61 on one side thereof and terminal section 66 of the contact 55 is brought into contact with the lower edge of the through-hole 61 on the opposite side thereof.

The contact 55 may, of course, has optional cross-sectional shapes such as rectangle, square, circle, oval or convex as in the first to third embodiments as above.

FIG. 28 illustrates a modification of the latch arm 59 of the IC socket 50 shown in FIGS. 20 to 27. As illustrated, there is a taper 59a in a tip end portion of a latch arm 59A so that an amount S of sliding is obtained. The sliding amount S may be variable by changing a width B of a root portion and a width E of a tip end portion of the latch arm 59A.

If the taper 59a is provided in the tip end portion of the latch arm 59A as described above, the taper 59a is brought into contact with the upper edge of the through-hole 61 in the printed circuit board 60 and slid along the same, resulting in a favorable contact. Also, the contact between the terminal section 66 of the contact 55 and the printed circuit board 60 is reliable. Accordingly, the favorable electric connection of the terminal section 66 of the contact 55 with the printed circuit board 60 is obtainable.

In addition, since a lower tip end portion of the terminal section 66 of the contact 55 is inserted into an array hole 67 of a contact-array plate 58 in the IC socket 50, the contact 55 is correctly positioned to the printed circuit in the printed circuit board 60. In this regard, the contact-array plate 58 may be eliminated if unnecessary. That is, when the contacts 55 are favorably arranged and held by the contact-holding plate 54, the contact-array plate 58 is unnecessary and can be eliminated.

According to the inventive IC socket 50 of the above-mentioned structure, when the terminal section 66 of the contact 55 is inserted into the through-hole 61 of the printed circuit board 60, the socket body 51 of the IC socket 50 is made to slide in the horizontal direction by the tapered portion of the nib 69 in the latch arm 59. Thereby, since the terminal section 66 of the contact 55 is brought into contact with the upper and lower edges of the through-hole 61 in the printed circuit board 60, the electric connection of the contact 55 is made at a plurality of points. Also, the replacement of the IC socket 50 on the printed circuit board 60 is facilitated, as well as the stable and improved contact between the printed circuit board 60 and the contact 55 is obtainable at a plurality of points. Further more, since the soldering of the IC socket 50 becomes unnecessary, an IC socket capable of using a usual printed circuit board as well as responsive to various through-holes different in diameter by changing the siding amount is obtainable.

As described hereinabove, according to the present invention, since the contact between the peripheral edge of the through-hole in the printed circuit board and the terminal is obtained, while using the elasticity of the terminal, by sliding the socket on the surface of the printed circuit board in which the through-holes are formed after the terminal has been inserted into the through-hole of the printed circuit board, it is possible to obtain the stable and secure contact between the printed circuit board and the contact at a plurality of points. Accordingly, the soldering of the socket becomes unnecessary and the replacement of the socket on the circuit board is enhanced. Also, a usual printed circuit board is usable for the socket.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A method for providing a socket on a substrate, comprising the steps of:
inserting a contact terminal section of a contact provided in the socket into a hole provided in said substrate;
sliding said socket relative to a surface of said substrate on which said hole is provided, while maintaining the state in which said contact terminal section is inserted into said hole provided in said substrate; and
fixing said socket and said contact terminal section to said substrate, while maintaining the state in which said socket and said contact terminal section are made to slide.

2. A method for providing a socket on a substrate, comprising the steps of:
inserting said contact terminal section of said contact provided in a socket and a latch arm into respective holes provided in said substrate;
sliding said socket relative to a surface of said substrate on which said hole is provided, while maintaining the state in which said contact terminal section and said latch arm are inserted into said holes provided in said substrate; and
fixing said socket, said contact terminal section, and said latch arm to said substrate, while maintaining the state in which said socket, said contact terminal section and said latch arm are made to slide.

3. A method for providing a socket on a substrate as claimed in claim 1, wherein said step of sliding said socket relative to a surface of said substrate on which a hole is provided is the state in which said socket is made to slide horizontally on said surface of said substrate on which said hole is provided by a cam mechanism provided in said substrate.

4. A method for providing a socket on a substrate as claimed in claim 1, wherein said step of sliding said socket relative to a surface of said substrate on which a hole is provided is the state in which said socket is made to slide horizontally on said surface of said substrate on which said hole is provided, and an amount of said sliding is determined by changing a width of a root portion and a width of a tip end portion of said latch arm.

5. A socket comprising:
a socket body;
a contact provided in said socket body; and
a slide mechanism provided in said socket body, including at least one pair of latch arms, said slide mechanism for sliding said socket body relative to a substrate to be mounted thereto.

6. A socket as claimed in claim 5, wherein a projection is provided in said contact terminal section of said contact.
